(19) United States
(12) Patent Application Publication
(10) Pub. No.: US 2024/0123481 A1
(43) Pub. Date: Apr. 18, 2024

(54) FOIL TAB FORMING APPARATUS AND FOIL TAB FORMING METHOD

(71) Applicant: LG ENERGY SOLUTION, LTD., Seoul (KR)

(72) Inventors: Jae-Won LIM, Daejeon (KR); Hak-Kyun KIM, Daejeon (KR); Jong-Sik PARK, Daejeon (KR); Je-Jun LEE, Daejeon (KR)

(73) Assignee: LG ENERGY SOLUTION, LTD., Seoul (KR)

(21) Appl. No.: 18/278,123

(22) PCT Filed: Mar. 8, 2022
(86) PCT No.: PCT/KR2022/003284

§ 371 Date: Aug. 21, 2023

(30) Foreign Application Priority Data
Mar. 8, 2021 (KR) 10-2021-0030278
Oct. 15, 2021 (KR) 10-2021-0137853

(51) Int. Cl. B21D 11/10; B21D 11/22; H01M 10/04; H01M 50/533; H01M 50/538

(52) U.S. Cl. CPC B21D 11/10; B21D 11/22; H01M 10/0431; H01M 50/533; H01M 50/538

(57) ABSTRACT

A foil tab forming apparatus forms at least one foil tab of a positive electrode foil tab and a negative electrode foil tab respectively provided at a top portion and a bottom portion of an electrode assembly. The foil tab forming apparatus includes a pre-forming jig configured to bend the foil tab by pressing the foil tab, while moving in a direction from an outer circumferential portion of the electrode assembly to a winding center portion of the electrode assembly and a forming jig configured to press the foil tab that has been primarily bent by the pre-forming jig, by moving along a direction parallel to a winding axis of the electrode assembly.

### TECHNICAL FIELD

The present disclosure relates to a foil tab forming apparatus and a foil tab forming method.

The present application claims priority to Korean Patent Application No. 10-2021-0030278 filed on Mar. 8, 2021, Korean Patent Application No. 10-2021-0137853 filed on Oct. 15, 2021 in the Republic of Korea, the disclosures of which are incorporated herein by reference.

### BACKGROUND ART

A structure connecting an uncoated portion of an electrode assembly and an external terminal with a welded tab in a cylindrical secondary battery is known in the prior art. However, this structure has issues of a limited current path and high self-resistance of the electrode assembly.

To resolve these issues, a method of increasing the number of tabs connected to the electrode assembly has been attempted, but application of such a method still has limits. To resolve these issues, using a positive electrode uncoated portion and a negative electrode uncoated portion provided respectively at a top portion and a bottom portion of the electrode assembly as tabs may be considered. In other words, creating an electric connection by using a positive electrode foil tab and a negative electrode foil tab respectively extending upward and downward in parallel to a winding center axis of the electrode assembly may be considered.

As such, when the positive electrode uncoated portion and the negative electrode uncoated portion having shapes respectively extending to the top portion and the bottom portion of the electrode assembly are used as the tabs, the positive electrode uncoated portion and the negative electrode uncoated portion may be bent to increase a combining area with a current collection plate.

Accordingly, development of a forming apparatus facilitating a process of bending the positive electrode uncoated portion and the negative electrode uncoated portion of the electrode assembly, and a forming method using the forming apparatus is required.

### DISCLOSURE

### Technical Problem

The present disclosure is designed to solve the problems of the related art, and therefore the present disclosure is directed to facilitating a process of forming a positive electrode foil tab and/or a negative electrode foil tab of an electrode assembly.

Also, the present disclosure is directed to uniformly forming a positive electrode foil tab and/or a negative electrode foil tab of an electrode assembly throughout an entire region from an outer circumferential portion of the electrode assembly to a winding center portion of the electrode assembly.

However, the technical problems to be solved in the present disclosure are not limited to the above, and other problems that are not mentioned could be clearly understood by one of ordinary skill in the art from the description of the present disclosure below.

### Technical Solution

In one aspect of the present disclosure, there is provided a foil tab forming apparatus for forming a foil tab of an electrode assembly that includes a winding axis, an outer circumferential portion and a winding center portion, the foil tab forming apparatus comprising: a forming jig configured to press the foil tab by moving along a direction parallel to the winding axis of the electrode assembly.

The foil tab forming apparatus may further comprise a pre-forming jig configured to bend the foil tab by pressing the foil tab, while moving radially inward.

The forming jig may be configured to press the foil tab that has been bent by the pre-forming jig.

The pre-forming jig may comprise a plurality of shutter blocks disposed along a circumference of the outer circumferential portion of the electrode assembly and bend the foil tab by moving radially inward.

The shutter block may have a surface facing the foil tab, the surface being inclined upward in a radial inward direction.

A width of the forming jig may be equal to or greater than a diameter of the electrode assembly.

The forming jig may be configured to rotate based on a same axis as the winding axis of the electrode assembly.

The forming jig may be configured to rotate in a clockwise direction or in a counterclockwise direction.

The forming jig may be configured to press the foil tab while rotating.

The forming jig may have a surface facing the foil tab, the surface being inclined upward in a radial inward direction.

The forming jig may comprise: a first pressing block provided at a location corresponding to a first region of the foil tab, the first region being adjacent to the outer circumferential portion of the electrode assembly; and a second pressing block provided at a location corresponding to a second region of the foil tab, the second region being adjacent to the winding center of the electrode assembly.

A pressing surface of the first pressing block and a pressing surface of the second pressing block may have a same inclination angle and define the surface of the forming jig facing the foil tab.

The first pressing block and the second pressing block may be configured to be independently movable along a direction parallel to the winding axis of the electrode assembly.

The forming jig may be configured to perform primary pressing as the first pressing block and the second pressing block move together towards the foil tab while the pressing surface of the first pressing block and the pressing surface of the second pressing block form the continuous surface, and then perform secondary pressing as the second pressing block moves further towards the foil tab while a location of the first pressing block is maintained.

The forming jig may be configured such that, after the primary pressing and the secondary pressing are completed, a lowest portion of the second pressing block is located at a height equal to or higher than a lowest portion of the first pressing block.

The first pressing block and the second pressing block may be configured to rotate independently or together.

The forming jig may comprise: a first pressing block provided at a location corresponding to a first region of the foil tab, the first region being adjacent to the outer circumferential portion of the electrode assembly; a third pressing block provided at a location corresponding to a third region of the foil tab, the third region being adjacent to the winding center portion of the electrode assembly; and a second pressing block provided at a location corresponding to a second region of the foil tab, the second region being located between the first region and the third region.

The forming jig may be provided as a pair of forming jigs disposed at opposite ends of the electrode assembly along the winding axis of the electrode assembly.

The pair of forming jigs may rotate in opposite directions.

The pre-forming jig may be provided as a pair of pre-forming jigs disposed at opposite ends of the electrode assembly along the winding axis of the electrode assembly.

In another aspect of the present disclosure, there is also provided a foil tab forming method for forming a foil tab of an electrode assembly that includes an outer circumferential portion and a winding center portion defining a winding axis, the foil tab forming method comprising steps of: (S1) bending the foil tab by pressing the foil tab along a direction parallel to the winding axis of the electrode assembly by using a forming jig.

The foil tab forming method may further comprise: (S0) bending the foil tab by pressing the foil tab in a radial inward direction by using a pre-forming jig, prior to the step (S1).

The step (S1) may be a step of additionally bending the foil tab by pressing the foil tab that has been pre-formed according to the step (S0).

The step (S0) may be performed by using the pre-forming jig including a plurality of shutter blocks disposed along a circumference of the outer circumferential portion of the electrode assembly and bending the foil tab by moving radially inward.

The step (S0) may be performed by using the pre-forming jig including the plurality of shutter blocks having a surface facing the foil tab, the surface having an upward inclined shape in a radially inward direction.

The step (S1) may be performed by using the forming jig having a width equal to or greater than a diameter of the electrode assembly.

The step (S1) may be performed by rotating the forming jig about the winding axis of the electrode assembly.

The step (S1) may be performed by simultaneously pressing the foil tab and rotating the forming jig.

In the step (S1), the forming jig may rotate in a clockwise direction so that the foil tab is oriented in the clockwise direction.

In the step (S1), the forming jig may rotate in a counterclockwise direction so that the foil tab is oriented in the counterclockwise direction.

The step (S1) may be performed by using the forming jig having a surface facing the foil tab, the surface having an upward inclined shape along a radially inward direction.

The step (S1) may be performed by using the forming jig comprising a first pressing block provided at a location corresponding to a first region of the foil tab, the first region being adjacent to the outer circumferential portion of the electrode assembly, and a second pressing block provided at a location corresponding to a second region of the foil tab, the second region being adjacent to the winding center of the electrode assembly.

The step (S1) may be performed by using the forming jig in which a pressing surface of the first pressing block and a pressing surface of the second pressing block have a same inclination.

The step (S1) may be performed by using the forming jig configured such that the first pressing block and the second pressing block are independently movable along a direction parallel to the winding axis of the electrode assembly.

The step (S1) may comprise (S11) performing primary pressing as the first pressing block and the second pressing block move together towards the foil tab while the pressing surface of the first pressing block and the pressing surface of the second pressing block form the continuous surface; and (S12) after the step (S11) is performed, performing secondary pressing as the second pressing block further moves towards the foil tab while a location of the first pressing block is maintained.

After the step (S11) and the step (S12) are performed, a lowest portion of the second pressing block may be located at a height equal to or higher than a lowest portion of the first pressing block.

The step (S1) may be performed as the first pressing block and the second pressing block rotate together or independently.

The step (S1) may be performed by using the forming jig comprising a first pressing block provided at a location corresponding to a first region of the foil tab, the first region being relatively adjacent to the outer circumferential portion of the electrode assembly, a third pressing block provided at a location corresponding to a third region of the foil tab, the third region being relatively adjacent to the winding center portion of the electrode assembly, and a second pressing block provided at a location corresponding to a second region of the foil tab, the second region being located between the first region and the third region.

The step (S1) may be performed by using the forming jig in which a pressing surface of the first pressing block, a pressing surface of the second pressing block and a pressing surface of the third pressing block have the same inclination.

The step (S1) may comprise steps of: (S11) performing primary pressing as the first pressing block, the second pressing block and the third pressing block move together towards the foil tab while the pressing surface of the first pressing block, the pressing surface of the second pressing block and the pressing surface of the third pressing block form the continuous surface; (S12) after the step (S11) is performed, performing secondary pressing as the second pressing block and the third pressing block move towards the foil tab while the pressing surface of the second pressing block and the pressing surface of the third pressing block form the continuous surface and a location of the first pressing block is maintained; and (S13) after the step (S12) is performed, performing tertiary pressing as the third pressing block moves towards the foil tab while a location of the first pressing block and a location of the second pressing block are maintained.

The step (S1) may be performed by using the forming jig provided as a pair of forming jigs disposed at both opposite ends of the electrode assembly along the winding axis of the electrode assembly.

The step (S1) may be performed by rotating the pair of forming jigs in opposite directions.

The step (S0) may be performed by using the pre-forming jig provided as a pair of pre-forming jigs disposed at opposite ends of the electrode assembly along the winding axis of the electrode assembly.

### Advantageous Effects

According to the present disclosure, a process of forming a positive electrode foil tab and/or a negative electrode foil tab of an electrode assembly can be facilitated.

In addition, according to the present disclosure, a positive electrode foil tab and/or a negative electrode foil tab of an electrode assembly can be uniformly formed throughout an entire region from an outer circumferential portion of the electrode assembly to a winding center portion of the electrode assembly.

However, the technical problems to be solved in the present disclosure are not limited to the above, and other problems that are not mentioned could be clearly understood by one of ordinary skill in the art from the description of the present disclosure below.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a partial side view of an electrode assembly and a current collection plate.

FIG. 2 is a top view of an electrode assembly having folded electrode tabs.

FIG. 3 is a side view of a pre-forming jig configuring a foil tab forming apparatus, according to an embodiment of the disclosure.

FIG. 4 is a side view showing a forming jig configuring a foil tab forming apparatus, according to an embodiment of the disclosure.

FIG. 5 is a side view of a second pressing block included in the forming jig shown in FIG. 4.

FIG. 6 is a side view of primary pressing performed by the forming jig shown in FIG. 4.

FIG. 7 is a side view of secondary pressing performed by the forming jig shown in FIG. 4.

FIG. 8 is a side view of a forming jig configuring a foil tab forming apparatus, according to another embodiment of the present disclosure.

FIG. 9 is a perspective view of the forming jig of the present disclosure.

FIG. 10 is an exploded view of the forming jig of the present disclosure.

FIG. 11 is a view showing an orientation form of the foil tab formed by the forming jig of the present disclosure rotating in a counterclockwise direction.

FIG. 12 is a flowchart of the method for forming the foil tab according to an embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

A foil tab forming apparatus of the present disclosure is an apparatus configured such that at least one foil tab of a positive electrode foil tab and a negative electrode foil tab provided respectively at a top portion and a bottom portion of a jelly-roll type electrode assembly is easily formed.

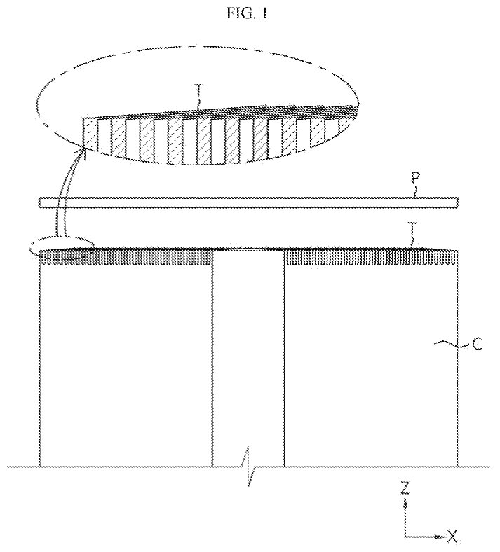

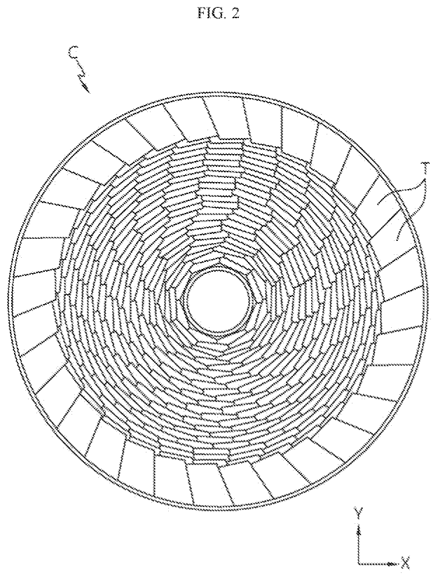

Referring to FIGS. 1 and 2, a structure of a foil tab T formed by the foil tab forming apparatus of the present disclosure is illustrated. The foil tab T refers to a first electrode uncoated portion extending upward along a direction parallel to a winding axis of an electrode assembly C (a direction parallel to a Z-axis of FIG. 1) and/or a second electrode uncoated portion extending downward (the direction parallel to the Z-axis of FIG. 1). The electrode assembly C has a structure in which a stack including a first electrode, a second electrode, and a separation film interposed between the first electrode and the second electrode is wound based on the winding axis. In the present specification, an example in which the first electrode is a positive electrode and the second electrode is a negative electrode will be described. The positive electrode includes a positive electrode uncoated portion formed in an end portion at one side in a width direction based on the stack before winding, and the negative electrode includes a negative electrode uncoated portion formed in an end portion at another side in the width direction based on the stack before winding. When the stack including the positive electrode and the negative electrode is wound to form the electrode assembly C, the positive electrode uncoated portion (a positive electrode active material uncoated region) is provided at an upper end portion of the electrode assembly C and the negative electrode uncoated portion (a negative electrode active material uncoated region) is provided at a lower end portion thereof.

An aluminum foil may be used as an electrode plate constituting the positive electrode, and a copper foil may be used as an electrode plate constituting the negative electrode. Thus, in the present specification, the positive electrode uncoated portion and the negative electrode uncoated portion will be each referred to as the foil tab T. The positive electrode foil tab and the negative electrode foil tab have shapes extending upward and downward of the electrode assembly C, respectively, i.e., shapes extending in opposite directions.

A current collection plate P is combined to the foil tab T. In order to improve a combining force between the current collection plate P and the foil tab T and reduce electric resistance at a combining portion, it is necessary to form a combining interface as flat as possible to widen a combining area between the foil tab T and the current collection plate P as much as possible. In this regard, the foil tab T may be bent such that an end portion of the foil tab T extends in a direction parallel to the current collection plate P. For smoothness of the bending, one foil tab continuously formed from a winding center portion to an outermost side of the electrode assembly may be, for example, notched as shown in FIG. 2 to a plurality of segments and then bend the foil tab.

The foil tab forming apparatus of the present disclosure is characterized in that the foil tab is configured to be smoothly and uniformly bent throughout a region from the outer circumferential portion of the electrode assembly C to the winding center portion.

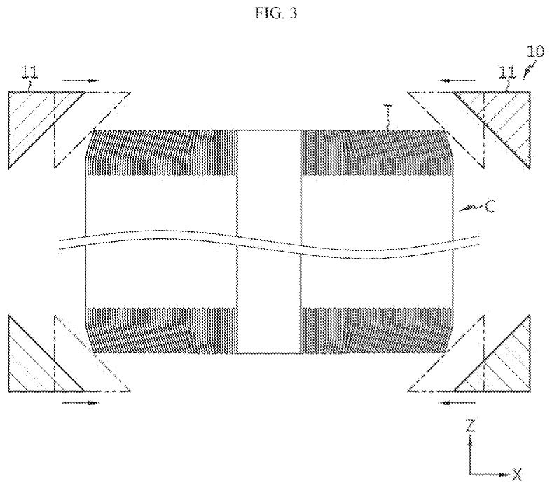

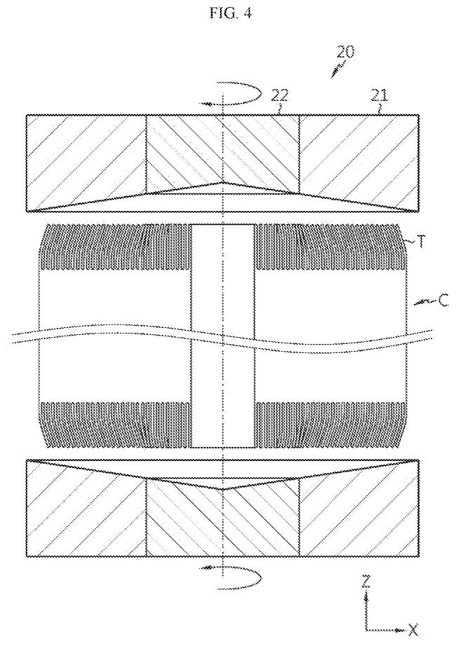

Referring to FIGS. 3 and 4, the foil tab forming apparatus is an apparatus for forming the at least one foil tab T of the positive electrode foil tab and the negative electrode foil tab respectively provided at the top portion and the bottom portion of the electrode assembly C. The foil tab forming apparatus may include a forming jig 20 configured to form the foil tab T, and may further include a pre-forming jig 10 configured to perform pre-forming before the foil tab T is formed by the forming jig 20. In this specification, the foil tab forming apparatus of the present disclosure is described on the premise that it includes both the pre-forming jig 10 and the forming jig 20, but the foil tab forming apparatus of the present disclosure may also be configured not to include the pre-forming jig 10. Even in this case, as explained later, the forming jig 20 of the present disclosure may be configured to perform intensive forming with a time interval for each area of the foil tab T, so that uniform and accurate forming may be performed over the entire area of the foil tab T.

Referring to FIG. 3, the pre-forming jig 10 is configured to press and bend the foil tab T while moving in a direction from the outer circumferential portion of the electrode assembly C to the winding center portion of the electrode assembly C. The pre-forming jig 10 may be provided as a pair of pre-forming jigs 10 respectively disposed at both opposite ends of the electrode assembly C along the winding axis of the electrode assembly C. The pre-forming jig 10 may include a plurality of shutter blocks 11. The plurality of shutter blocks 11 are disposed along a circumference of the outer circumferential portion of the electrode assembly and configured to bend the foil tab T while moving radially inwardly of the electrode assembly C. The shutter block 11 may have a surface facing the foil tab T, the surface having an upward inclined shape along the direction from the outer circumferential portion of the electrode assembly C to the winding center portion of the electrode assembly C. That is, each shutter block 11 may have a surface inclined upward such that the thickness of the shutter block 11 decreases from the outside to the inside.

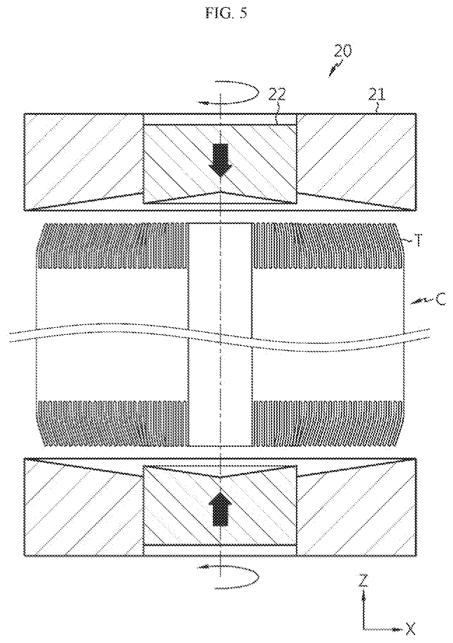

Referring to FIGS. 4 and 5 together with FIG. 3, the forming jig 20 is configured to press the foil tab T that has been completely pre-formed by the pre-forming jig 10, by moving along a direction parallel to the winding axis of the electrode assembly C. The forming jig 20 may have, for example, a shape approximately similar to a cylinder. The forming jig 20 may be provided as a pair of forming jigs respectively disposed at both opposite ends of the electrode assembly C along the winding axis of the electrode assembly C.

The forming jig 20 may have a width equal to or greater than a diameter of the electrode assembly C. This is to form an entire region of the foil tab T during the pressing performed by using the forming jig 20. The forming jig 20 may be configured to rotate based on the same axis as the winding axis of the electrode assembly C. If the forming jig 20 is provided in a pair and respectively provided at both ends of the electrode assembly C in the height direction (parallel to the Z-axis), the pair of forming jigs 20 may rotate in opposite directions. The forming jig 20 may be configured to simultaneously perform an operation of pressing the foil tab T and an operation of rotating. When the pressing and rotation are performed together, more smooth and natural bending is possible. If the rotation direction of the forming jig 20 is a clockwise direction, the foil tab T may be oriented in the clockwise direction (see FIG. 2). Conversely, if the rotation direction of the forming jig 20 is a counterclockwise direction, the foil tab T may be oriented in the counterclockwise direction (see FIG. 11).

The forming jig 20 may have a surface facing the foil tab T, the surface having an upward inclined shape along the direction from the outer circumferential portion of the electrode assembly C to the winding center portion. That is, the forming jig 20 may have a surface inclined upward so that the thickness of the forming jig 20 decreases from the outside to the center. According to such a structure of the forming jig 20, a phenomenon, in which the electrode assembly C is damaged due to excessive force applied to the foil tab T when the foil tab T is pressed, may be prevented, and natural bending may be achieved.

The forming jig 20 may include a first pressing block 21 and a second pressing block 22. The first pressing block 21 is provided at a location corresponding to a first region of the foil tab T, the first region being relatively adjacent to the outer circumferential portion of the electrode assembly C. The second pressing block 22 is provided at a location corresponding to a second region of the foil tab T, the second region being relatively adjacent to the winding center of the electrode assembly C. For example, when the forming jig 20 has a shape approximately similar to a cylinder, the first pressing block 21 may have an annular shape with an empty center portion, and the second pressing block 22 may be disposed in the empty center portion of the first pressing block 21.

A pressing surface of the first pressing block 21 and a pressing surface of the second pressing block 22 may have an approximately same inclination. In this case, the pressing surface of the first pressing block 21 and the pressing surface of the second pressing block 22 may form an approximately continuous surface, which may be a conical surface. That is, the pressing surface of the first pressing block 21 and the pressing surface of the second pressing block 22 may be connected to each other to define a surface of the forming jig 20 facing the foil tab T.

The first pressing block 21 and the second pressing block 22 may be configured to be independently movable along a direction parallel to the winding axis of the electrode assembly C (a direction parallel to the Z-axis). For example, as shown in FIG. 5, the second pressing block 22 may additionally move in a direction facing the foil tab T while the first pressing block 21 is stopped.

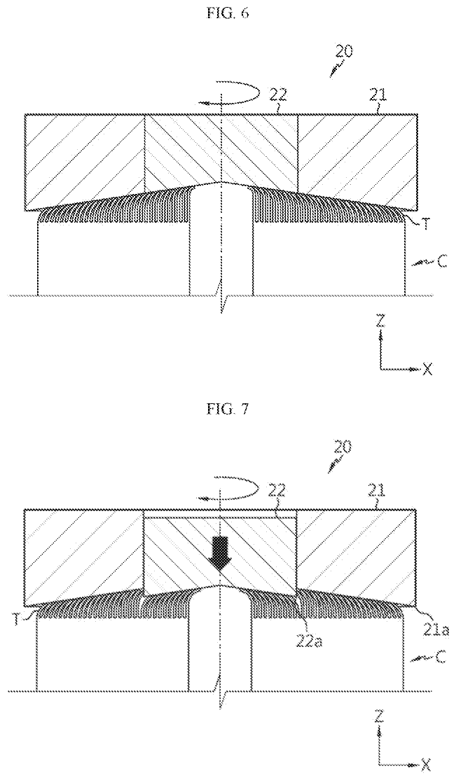

Referring to FIGS. 6 and 7, the forming jig 20 may be configured such that first pressing block 21 and the second pressing block 22 perform the primary pressing by moving towards the foil tab T together, while the pressing surface of the first pressing block 21 and the pressing surface of the second pressing block 22 form the continuous surface. Also, the forming jig 20 may be configured such that the second pressing block 22 performs the secondary pressing by further moving towards the foil tab T while a location of the first pressing block 21 is maintained, after the primary pressing is performed. As such, when the forming jig 20 includes the plurality of pressing blocks 21 and 22 and performs additional pressing by using the pressing block 22 located closer to the center portion, more elaborate forming may be achieved. Due to an inclined direction of the pressing surface of the forming jig 20, a bending point of the foil tab T moves radially inwardly towards an end portion of the foil tab T in a direction from the outer circumferential portion of the electrode assembly C to the winding center portion, during the pressing. Accordingly, when the additional pressing is performed by using the second pressing block 22, a deviation of such a bending point may be reduced.

Meanwhile, the forming jig 20 may be configured such that, after the primary pressing and the secondary pressing are completed, a lowest portion 22a of the second pressing block 22 is located at a height equal to or higher than a lowest portion 21a of the first pressing block 21. This is because, when the pressing by the second pressing block 22 is excessively deeply performed, a bending location deviation at a boundary point between the first pressing block 21 and the second pressing block 22 may become too big.

The first pressing block 21 and the second pressing block 22 may be configured to rotate independently or together based on the same axis as the winding axis of the electrode assembly C. In other words, the first pressing block 21 and the second pressing block 22 may be connected to one driving means and rotate together, or may be connected to separate driving means respectively and rotate independently.

The first pressing block 21 and the second pressing block 22 may move towards the foil tab T while the pressing surfaces thereof form an approximately continuous surface to bend the foil tab T (primary forming) through pressing and rotation, and then perform additional bending (secondary forming) through additional pressing and rotation, by using the second pressing block 22 while a rotation state of the first pressing block 21 is maintained. The first region of the foil tab T may be intensively formed by the primary forming. Of course, while the first region is intensively formed, the second region may also be formed together. In addition, the second region of the foil tab T may be intensively formed by the secondary forming. While the second region is intensively formed, the first region may also be continuously formed.

Whether or not the remaining region is continuously formed while any one of the first region and the second region is intensively formed may be determined according to the location of the forming jig 20 in the vertical direction (direction parallel to the Z-axis).

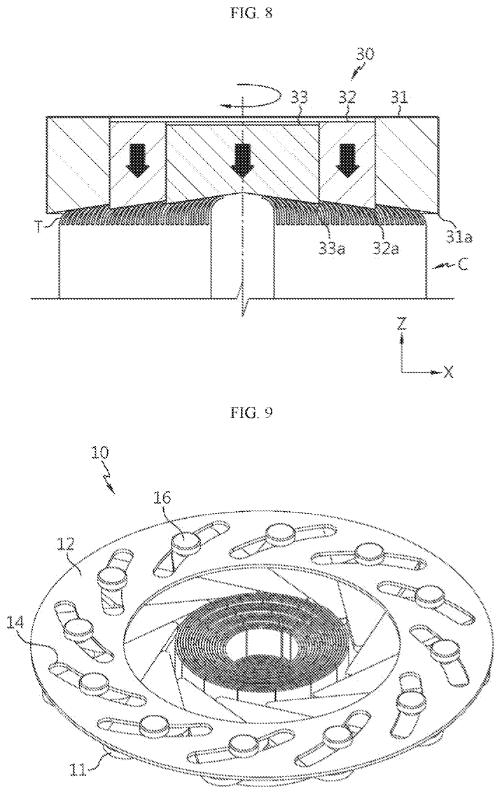

Meanwhile, referring to FIG. 8, unlike the forming jig 20 shown in FIGS. 4 through 7, a forming jig 30 including three pressing blocks 31, 32, and 33 is illustrated. However, the number of pressing blocks 21 and 22, or 31, 32, and 33 included in the forming jig 20 or 30 is not limited to 2 or 3, and a greater number of pressing blocks may be provided for more elaborate forming.

The first pressing block 31 may be provided at a location corresponding to a first region of the foil tab T, the first region being relatively adjacent to the outer circumferential portion of the electrode assembly C. The third pressing block 33 may be provided at a location corresponding to a third region of the foil tab T, the third region being adjacent to the core side, namely the winding center portion, of the electrode assembly C. The second pressing block 32 may be provided at a location corresponding to a second region of the foil tab T, the second region being located between the first region and the third region. The pressing surfaces of the first pressing block 31, the second pressing block 32 and the third pressing block 33 may have approximately the same inclination. Accordingly, the inclined surfaces of the first pressing block 31, the second pressing block 32 and the third pressing block 33 may define a surface of the forming jig facing the foil tab T.

As shown in FIG. 8, when the forming jig 30 includes a first pressing block 31, a second pressing block 32, and a third pressing block 33, the three pressing blocks 31, 32, and 33 may form the foil tab T (primary forming) by moving towards the foil tab T and rotating while pressing surfaces thereof form an approximately continuous surface. The first region of foil tab T may be intensively formed by the primary forming. Of course, while the first region is being intensively formed, the second region and the third region may also be formed together. After the primary forming is completed as above, the second pressing block 32 and the third pressing block 33 may similarly perform pressing and rotation by additionally moving while maintaining a state in which the pressing surfaces thereof form the approximately continuous surface, thereby forming the foil tab T (secondary forming). The second region of the foil tab T may be intensively formed by the secondary forming. Here, a rotating state of the first pressing block 31 may be continuously maintained, and thus the first region and the third region may also be continuously formed while the second region is intensively formed. The third pressing block 33 may perform pressing and rotation by additionally moving after the additional pressing is performed by the second pressing block 32, thereby forming the foil tab T (tertiary forming). The third region of the foil tab T may be intensively formed by the tertiary forming. At this time, rotating states of the first pressing block 31 and the second pressing block 32 may be continuously maintained, and thus the first region and the second region may also be continuously formed while the third region is intensively formed.

Whether or not the remaining regions are continuously formed while any one of the first region, the second region and the third region is intensively formed may be determined according to the location of the forming jig 20 in the vertical direction (direction parallel to the Z-axis).

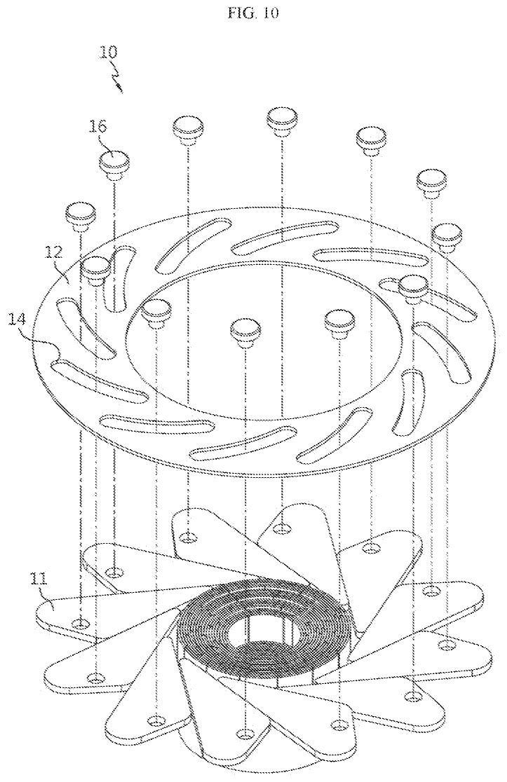

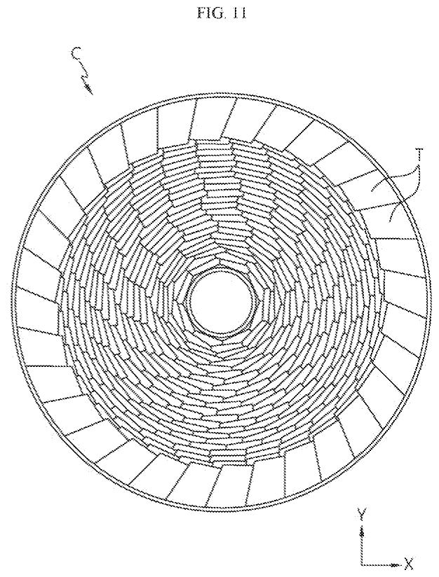

Referring to FIGS. 3, 9 and 10, an exemplary form of the pre-forming jig 10 is shown. The pre-forming jig 10 may include, for example, a shutter frame 12 having a plurality of slots 14. Each shutter block 11 may be supported by a guide member 16 extending through the slot 14, inside the corresponding slot 14. The guide member 16 may move inside the slot 14 as the shutter frame 12 rotates based on an axis parallel to the winding axis of the electrode assembly C. The slot 14 may have a curved shape so that the shutter block 11 may easily move toward and away from the winding axis of the electrode assembly C. The overall movement of the shutter block 11 may be similar to, for example, opening and closing of the iris. That is, the shutter block 11 may be coupled to the shutter frame 12 and configured to perform a closing operation for moving toward the electrode assembly C and an opening operation for moving away from electrode assembly C, which is disposed in an empty space formed at the center of the shutter frame 12. Meanwhile, the shutter block 11 may be opened/closed by rotation of the shutter frame 12, or may be opened/closed by moving the guide member 16 in the extending direction of the slot 14.

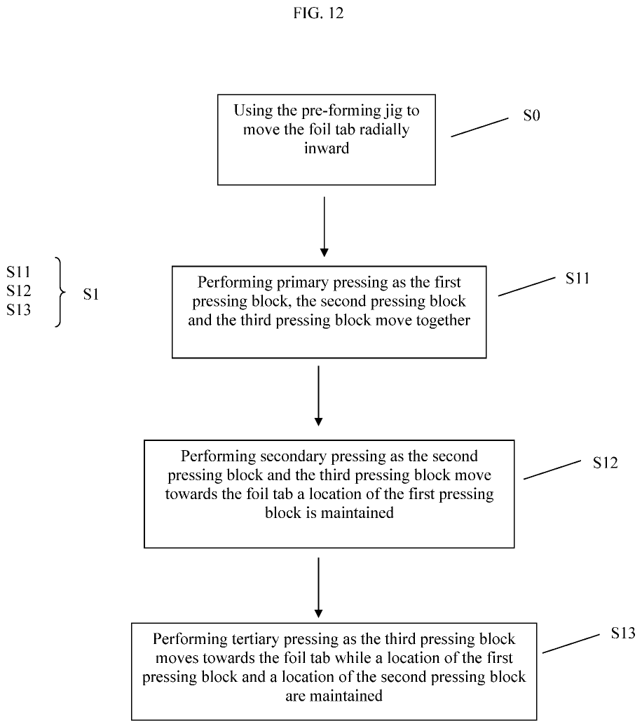

Next, a foil tab forming method of the present disclosure will be described with reference to FIG. 12. The foil tab forming method of the present disclosure is a method of forming the foil tab T of the electrode assembly C by using the foil tab forming apparatus of the present disclosure described above.

Referring to FIGS. 3 through 8 that have been referred to above, the foil tab forming method of the present disclosure is a method of forming the at least one foil tab T of the positive electrode foil tab and the negative electrode foil tab respectively provided at the top portion and the bottom portion of the electrode assembly C.

The foil tab forming method is a method of forming a foil tab T of an electrode assembly C having an outer circumferential portion and a winding center portion defining a winding axis, and includes the step of (S1) bending the foil tab T by pressing the foil tab T along a direction parallel to the winding axis of the electrode assembly C by using a forming jig 20. The foil tab forming method may further include the step of (S0) bending the foil tab T by pressing the foil tab T in a direction from the outer circumferential portion of the electrode assembly C toward the winding center portion of the electrode assembly C by using a pre-forming jig 10 prior to the step (S1). In this case, the step (S1) may be a step of additionally bending the foil tab T by pressing the foil tab T that has been pre-formed according to the step (S0).

The step (S0) may be performed by using the pre-forming jig 10 including a plurality of shutter blocks 11 disposed along a circumference of the outer circumferential portion of the electrode assembly C and bending the foil tab T by moving along a direction toward the winding center portion of the electrode assembly C. The step (S0) may be performed by using the pre-forming jig 10 having a plurality of shutter blocks 11 having a surface facing the foil tab T, the surface being inclined upward in a direction from the outer circumferential portion of the electrode assembly C toward the winding center portion. The step (S0) may be performed by using a pair of pre-forming jigs 10 disposed at opposite ends of the electrode assembly C along the winding axis of the electrode assembly C. That is, the step (S0) may be a step of pre-forming each of the first foil tab (first polarity) and the second foil tab (second polarity) provided at both ends of the electrode assembly C in the height direction (parallel to the Z-axis). The pre-forming for the first foil tab and the pre-forming for the second foil tab may be performed at the same time or with a time interval.

The step (S1) may be performed by using the forming jig 20 having the width equal to or greater than the diameter of the electrode assembly C. The step (S1) may be performed by using the forming jig 20 configured to rotate based on the same axis as the winding axis of the electrode assembly C. The step (S1) may be performed by using the forming jig 20 configured such that an operation of pressing the foil tab T and an operation of rotating may be performed together. In the step (S1), the forming jig 20 may rotate in a clockwise direction so that the foil tab T is oriented in the clockwise direction. Alternatively, in the step (S1), the forming jig 20 may rotate in a counterclockwise direction so that the rotating foil tab T is oriented in the counterclockwise direction.

The step (S1) may be performed by using the forming jig 20 having the surface facing the foil tab T, the surface having the upward inclined shape along the direction from the outer circumferential portion of the electrode assembly C to the winding center portion. The step (S1) may be performed by using the forming jig 20 including the first pressing block 21 provided at the location corresponding to the first region of the foil tab T, the first region being adjacent to the outer circumferential portion of the electrode assembly C, and the second pressing block 22 provided at the location corresponding to the second region of the foil tab T, the second region being adjacent to the winding center of the electrode assembly C.

The step (S1) may be performed by the forming jig 20 in which the pressing surface of the first pressing block 21 and the pressing surface of the second pressing block 22 have the same inclination. The step (S1) may be performed by the forming jig 20 configured such that the first pressing block 21 and the second pressing block 22 are independently movable along the direction parallel to the winding axis of the electrode assembly C.

The step (S1) may include steps of: (S11) performing the primary pressing as the first pressing block 21 and the second pressing block 22 move towards the foil tab together while the pressing surface of the first pressing block 21 and the pressing surface of the second pressing block 22 form the continuous surface; and (S12) performing the secondary pressing as the second pressing block 22 further moves towards the foil tab T while the location of the first pressing block 21 is maintained, after the step (S11) is performed. Here, the lowest portion 22a of the second pressing block after the steps (S11) and (S12) are performed may be located at a height equal to or higher than the lowest portion 21a of the first pressing block 21. The step (S1) may be performed as the first pressing block 21 and the second pressing block 22 rotate independently or together based on the same axis as the winding axis.

Meanwhile, the step (S1) may be performed by the forming jig 30 including a first pressing block 31 provided at a location corresponding to a first region of the foil tab T, the first region being adjacent to the outer circumferential portion of the electrode assembly C, a third pressing block 33 may be provided at a location corresponding to a third region of the foil tab T, the third region being adjacent to the winding center portion of the electrode assembly C, and a second pressing block 32 provided at a location corresponding to a second region of the foil tab T, the second region being located between the first region and the third region. The step (S1) may be performed by the forming jig 20 in which the pressing surface of the first pressing block 31, the pressing surface of the second pressing block 32, and the pressing surface of the third pressing block 33 have approximately the same inclination. In this case, the step (S1) may include the steps of (S11) performing primary pressing as the first pressing block 31, the second pressing block 32 and the third pressing block 33 move together towards the foil tab T while the pressing surface of the first pressing block 31, the pressing surface of the second pressing block 32 and the pressing surface of the third pressing block 33 form the continuous surface; (S12) after the step (S11) is performed, performing secondary pressing as the second pressing block 32 and the third pressing block 33 move towards the foil tab T while the pressing surface of the second pressing block 32 and the pressing surface of the third pressing block 33 form the continuous surface and a location of the first pressing block 31 is maintained; and (S13) after the step (S12) is performed, performing tertiary pressing as the third pressing block 33 moves towards the foil tab T while a location of the first pressing block 31 and a location of the second pressing block 32 are maintained. The step (S1) may be performed by using a pair of forming jigs 20 disposed at opposite ends of the electrode assembly C along the winding axis of the electrode assembly C. That is, the step (S1) may be a step of forming each of the first foil tab (first polarity) and the second foil tab (second polarity) provided at both ends of the electrode assembly C in the height direction (parallel to the Z-axis). In this case, the step (S1) may be performed by rotating the pair of forming jigs 20 in opposite directions based on the same axis as the winding axis of the electrode assembly C. The forming for the first foil tab and the forming for the second foil tab can be made at the same time or with a time interval.

As described above, according to the foil tab forming apparatus of the present disclosure and/or the foil tab forming method of the present disclosure, by dividing the foil tab T of the electrode assembly C into a plurality of regions along the approximately radial direction of the electrode assembly C and enabling each region to be intensively and individually formed, efficient and accurate forming is possible. Moreover, according to the foil tab forming apparatus of the present disclosure and/or the foil tab forming method of the present disclosure, rotation and pressurization may be simultaneously applied, and thus forming may be performed more smoothly.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### Explanation of Reference Numerals

C: electrode assembly
T: foil tab
P: current collection plate
10: pre-forming jig
11: shutter block
12: shutter frame
14: slot
16: guide member
20, 30: forming jig
21, 31: first pressing block
22, 32: second pressing block
33: third pressing block

1. A foil tab forming apparatus for forming a foil tab of an electrode assembly that includes a winding axis, an outer circumferential portion and a winding center portion, the foil tab forming apparatus comprising:
a forming jig configured to press the foil tab by moving along a direction parallel to the winding axis of the electrode assembly.

2. The foil tab forming apparatus of claim 1, further comprising a pre-forming jig configured to bend the foil tab by pressing the foil tab, while moving radially inward,
wherein the forming jig is configured to press the foil tab that has been bent by the pre-forming jig.

3. The foil tab forming apparatus of claim 2, wherein the pre-forming jig comprises a plurality of shutter blocks disposed along a circumference of the outer circumferential portion of the electrode assembly and configured to bend the foil tab by moving radially inwardly.

4. The foil tab forming apparatus of claim 3, wherein the shutter block has a surface facing the foil tab, the surface being inclined upward in a radial inward direction.

5. The foil tab forming apparatus of claim 1, wherein a width of the forming jig is equal to or greater than a diameter of the electrode assembly.

6. The foil tab forming apparatus of claim 1, wherein the forming jig is configured to rotate based on a same axis as the winding axis of the electrode assembly.

7. The foil tab forming apparatus of claim 6, wherein the forming jig is configured to rotate in a clockwise direction or in a counterclockwise direction.

8. The foil tab forming apparatus of claim 6, wherein the forming jig is configured to press the foil tab while rotating.

9. The foil tab forming apparatus of claim 1, wherein the forming jig has a surface facing the foil tab, the surface being inclined upward in a radial inward direction.

10. The foil tab forming apparatus of claim 9, wherein the forming jig comprises:
a first pressing block provided at a location corresponding to a first region of the foil tab, the first region being adjacent to the outer circumferential portion of the electrode assembly; and
a second pressing block provided at a location corresponding to a second region of the foil tab, the second region being adjacent to the winding center of the electrode assembly.

11. The foil tab forming apparatus of claim 10, wherein a pressing surface of the first pressing block and a pressing surface of the second pressing block have a same inclination angle and define the surface of the forming jig facing the foil tab.

12. The foil tab forming apparatus of claim 10, wherein the first pressing block and the second pressing block are configured to be independently movable along a direction parallel to the winding axis of the electrode assembly.

13. The foil tab forming apparatus of claim 11, wherein the forming jig is configured to perform primary pressing as the first pressing block and the second pressing block move together towards the foil tab while the pressing surface of the first pressing block and the pressing surface of the second pressing block form continuous surface, and then perform secondary pressing as the second pressing block moves further towards the foil tab while a location of the first pressing block is maintained.

14. The foil tab forming apparatus of claim 13, wherein the forming jig is configured such that, after the primary pressing and the secondary pressing are completed, a lowest portion of the second pressing block is located at a height equal to or higher than a lowest portion of the first pressing block.

15. The foil tab forming apparatus of claim 10, wherein the first pressing block and the second pressing block are configured to rotate independently or together.

16. The foil tab forming apparatus of claim 9, wherein the forming jig comprises:
a first pressing block provided at a location corresponding to a first region of the foil tab, the first region being adjacent to the outer circumferential portion of the electrode assembly;
a third pressing block provided at a location corresponding to a third region of the foil tab, the third region being adjacent to the winding center portion of the electrode assembly; and
a second pressing block provided at a location corresponding to a second region of the foil tab, the second region being located between the first region and the third region.

17. The foil tab forming apparatus of claim 1, wherein the forming jig is provided as a pair of forming jigs disposed at opposite ends of the electrode assembly along the winding axis of the electrode assembly.

18. The foil tab forming apparatus of claim 17, wherein the pair of forming jigs rotate in opposite directions.

19. The foil tab forming apparatus of claim 2, wherein the pre-forming jig is provided as a pair of pre-forming jigs disposed at opposite ends of the electrode assembly along the winding axis of the electrode assembly.

20. A foil tab forming method for forming a foil tab of an electrode assembly that includes an outer circumferential portion and a winding center portion defining a winding axis, the foil tab forming method comprising steps of:
(S1) bending the foil tab by pressing the foil tab along a direction parallel to the winding axis of the electrode assembly by using a forming jig.

21. The foil tab forming method of claim 20, further comprising:
(S0) bending the foil tab by pressing the foil tab in a radial inward direction by using a pre-forming jig, prior to the step (S1).

22. The foil tab forming method of claim 21, wherein the step (S0) is performed by using the pre-forming, jig including a plurality of shutter blocks disposed along a circumference of the outer circumferential portion of the electrode assembly and bending the foil tab by moving radially inwardly.

23. The foil tab forming method of claim 22, wherein the step (S0) is performed by using the pre-forming jig including the plurality of shutter blocks having a surface facing the foil tab, the surface having an upward inclined shape in a radially inward direction.

24. The foil tab forming method of claim 20, wherein the step (S1) is performed by using the forming jig having a width equal to or greater than a diameter of the electrode assembly.

25. The foil tab forming method of claim 20, wherein the step (S1) is performed by rotating the forming jig configured to rotate about the winding axis of the electrode assembly.

26. The foil tab forming method of claim 20, wherein the step (S1) is performed by simultaneously pressing the foil tab and rotating the forming.

27. The foil tab forming method of claim 26, wherein in the step (S1), the forming jig rotates in a clockwise direction so that the foil tab is oriented in the clockwise direction.

28. The foil tab forming method of claim 26, wherein in the step (S1), the forming jig rotates in a counterclockwise direction so that the foil tab is oriented in the counterclockwise direction.

29. The foil tab forming method of claim 20, wherein the step (S1) is performed by using the forming jig having a surface facing the foil tab, the surface having an upward inclined shape along a radially inward direction.

30. The foil tab forming method of claim 29, wherein the step (S1) is performed by using the forming jig comprising a first pressing block provided at a location corresponding to a first region of the foil tab, the first region being adjacent to the outer circumferential portion of the electrode assembly, and a second pressing block provided at a location corresponding to a second region of the foil tab, the second region being adjacent to the winding center of the electrode assembly.

31. The foil tab forming method of claim 30, wherein the step (S1) is performed by using the forming jig in which a pressing surface of the first pressing block and a pressing surface of the second pressing block have a same inclination.

32. The foil tab forming method of claim 30, wherein the step (S1) is performed by using the forming jig configured such that the first pressing block and the second pressing block are independently movable along a direction parallel to the winding axis of the electrode assembly.

33. The foil tab forming method of claim 31, wherein the step (S1) comprises:
(S11) performing primary pressing as the first pressing block and the second pressing block move together towards the foil tab while the pressing surface of the first pressing block and the pressing surface of the second pressing block form the continuous surface; and
(S12) after the step (S11) is performed, performing secondary pressing as the second pressing block further moves towards the foil tab while a location of the first pressing block is maintained.

34. The foil tab forming method of claim 33, wherein after the step (S11) and the step (S12) are performed, a lowest portion of the second pressing block is located at a height equal to or higher than a lowest portion of the first pressing block.

35. The foil tab forming method of claim 30, wherein the step (S1) is performed as the first pressing block and the second pressing block rotate together or independently.

36. The foil tab forming method of claim 29, wherein the step (S1) is performed by using the forming jig comprising a first pressing block provided at a location corresponding to a first region of the foil tab, the first region being relatively adjacent to the outer circumferential portion of the electrode assembly, a third pressing block provided at a location corresponding to a third region of the foil tab, the third region being relatively adjacent to the winding center portion of the electrode assembly, and a second pressing block provided at a location corresponding to a second region of the foil tab, the second region being located between the first region and the third region.

37. The foil tab forming method of claim 36, wherein the step (S1) is performed by using the forming jig in which a pressing surface of the first pressing block, a pressing surface of the second pressing block and a pressing surface of the third pressing block have the same inclination.

38. The foil tab forming method of claim 37, wherein the step (S1) comprises steps of:
(S11) towards the foil tab while the pressing surface of the first pressing block, the pressing surface of the second pressing block and the pressing surface of the third pressing block form the continuous surface;
(S12) after the step (S11) is performed, performing secondary pressing as the second pressing block and the third pressing block move towards the foil tab while the pressing surface of the second pressing block and the pressing surface of the third pressing block form the continuous surface and a location of the first pressing block is maintained; and
(S13) after the step (S12) is performed, performing tertiary pressing as the third pressing block moves towards the foil tab while a location of the first pressing block and a location of the second pressing block are maintained.

39. The foil tab forming method of claim 20, wherein the step (S1) is performed by using the forming jig provided as a pair of forming jigs disposed at opposite ends of the electrode assembly along the winding axis of the electrode assembly.

40. The foil tab forming method of claim 39, wherein the step (S1) is performed by rotating the pair of forming jigs in opposite directions.

41. The foil tab forming method of claim 21, wherein the step (S0) is performed by using the pre-forming jig provided as a pair of pre-forming jigs disposed at opposite ends of the electrode assembly along the winding axis of the electrode assembly.
